(19) United States
(12) Patent Application Publication
(10) Pub. No.: US 2026/0037771 A1
(43) Pub. Date: Feb. 5, 2026

(54) Graph Neural Network Based Conflict Mitigation

(71) Applicant: Dell Products L.P., Round Rock, TX (US)

(72) Inventors: Hoda Dehghan, Toronto (CA); Gwenael Poitau, Montreal (CA)

(21) Appl. No.: 18/795,103

(22) Filed: Aug. 5, 2024

(51) Int. Cl. G06N 3/042

(52) U.S. Cl. CPC G06N 3/042

(57) ABSTRACT

A system can input metrics of a broadband cellular network to a first graph neural network to produce first outputs, wherein respective first outputs of the first outputs indicate respective predicted probabilities that respective xApps of a group of xApps will cause a disturbance to operation of the broadband cellular network, wherein the broadband cellular network comprises an open radio access network architecture, and wherein the broadband cellular network is configured to execute the group of xApps. The system can input the first outputs, current network conditions of the broadband cellular network, and user demand data into a second graph neural network to produce a second output, wherein the second output comprises adjusting operation of at least one xApp of the group of xApps. The system can adjust the operation of the at least one xApp of the group of xApps based on the second output.

### BACKGROUND

A graph neural network (GNN) generally comprises a type of neural network that is configured to process data that can be represented as a graph.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can input metrics of a broadband cellular network to a first graph neural network to produce first outputs, wherein respective first outputs of the first outputs indicate respective predicted probabilities that respective xApps of a group of xApps will cause a disturbance to operation of the broadband cellular network, wherein the broadband cellular network comprises an open radio access network architecture, and wherein the broadband cellular network is configured to execute the group of xApps. The system can input the first outputs, current network conditions of the broadband cellular network, and user demand data into a second graph neural network to produce a second output, wherein the second output comprises adjusting operation of at least one xApp of the group of xApps. The system can adjust the operation of the at least one xApp of the group of xApps based on the second output.

An example method can comprise inputting, by a system comprising at least one processor, metrics of a broadband cellular network to a first graph neural network to produce first outputs, wherein the broadband cellular network comprises an open radio access network architecture that is configured to execute xApps, wherein respective first outputs of the first outputs indicate respective predicted probabilities that respective xApps of the xApps are going to cause a disturbance to operation of the broadband cellular network. The method can further comprise inputting, by the system, the first outputs, current network conditions of the broadband cellular network, and user demand data into a second graph neural network to produce a second output, wherein the second output comprises adjusting operation of an xApp of the xApps. The method can further comprise modifying, by the system, the operation of the xApp of the xApps based on the second output.

An example non-transitory computer-readable medium can comprise instructions that, in response to execution, cause a system comprising a processor to perform operations. These operations can comprise inputting metrics of a cellular network to a first graph neural network to produce first outputs, wherein the cellular network is configured to execute near-real time applications, wherein respective first outputs of the first outputs indicate respective predicted probabilities that respective near-real time applications of the near-real time applications will interfere with operation of the cellular network. These operations can further comprise inputting the first outputs, current network conditions of the cellular network, and user demand data into a second graph neural network to produce a second output, wherein the second output comprises adjusting operation of a near-real time application of the near-real time applications. These operations can further comprise changing the operation of the near-real time application based on the second output.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate GNN-based conflict mitigation, in accordance with an embodiment of this disclosure;

FIG. 2 illustrates another example system architecture that can facilitate GNN-based conflict mitigation, in accordance with an embodiment of this disclosure;

FIG. 3 illustrates an example system architecture of a GNN that can facilitate GNN-based conflict mitigation, in accordance with an embodiment of this disclosure;

FIG. 4 illustrates an example graph that can facilitate GNN-based conflict mitigation, in accordance with an embodiment of this disclosure;

FIG. 5 illustrates an example process flow that can facilitate GNN-based conflict mitigation, in accordance with an embodiment of this disclosure;

FIG. 6 illustrates another example process flow that can facilitate GNN-based conflict mitigation, in accordance with an embodiment of this disclosure;

FIG. 7 illustrates another example process flow that can facilitate GNN-based conflict mitigation, in accordance with an embodiment of this disclosure;

FIG. 8 illustrates another example process flow that can facilitate GNN-based conflict mitigation, in accordance with an embodiment of this disclosure;

FIG. 9 illustrates another example process flow that can facilitate GNN-based conflict mitigation, in accordance with an embodiment of this disclosure;

FIG. 10 illustrates another example process flow that can facilitate GNN-based conflict mitigation, in accordance with an embodiment of this disclosure; and

FIG. 11 illustrates an example block diagram of a computer operable to execute an embodiment of this disclosure.

### DETAILED DESCRIPTION

### Overview

The examples herein generally relate to fifth generation new radio (5G NR) broadband cellular communications. It can be appreciated that they can be applied to other types of broadband cellular communications, such as sixth generation (6G) technologies, and more generally to wireless communications.

The present techniques can be implemented to manage conflicts in a dynamic and multifaceted context of Open Radio Access Networks (O-RANs). The present techniques can utilize graph neural network (GNN) technology, which can be employed both for conflict detection, and also in a GNN-based xApp scheduling system. This dual GNN approach can offer a robust and comprehensive strategy to address challenges posed by multiple applications (xApps) operating within an O-RAN ecosystem.

The present techniques can integrate GNN-processed conflict detection outputs with a real-time, GNN-based xApp scheduling framework. A system that implements the present techniques can analyze probability metrics derived from the conflict detection GNN, and access the likelihood of xApp actions causing network disturbances. This information, when synthesized with network conditions and user demand data, can fuel an advanced scheduling technique. This scheduling technique can dynamically adjust xApp operations to meet overarching network objectives, such as throughput optimization or latency reduction, while simultaneously honoring the unique objectives and strategies of each individual xApp.

Through this dual application of GNN technology, the present techniques sets forth a novel approach for conflict resolution in O-RAN environments, enhancing network performance and reliability by preemptively addressing and resolving potential application conflicts.

An O-RAN architecture is pioneering the telecommunications industry, emphasizing flexibility, interoperability, and open standards. The radio access network (RAN) Intelligent Controllers (RICs) at various levels—non-Real Time (non-RT), near-Real Time (near-RT), and Real Time (RT)—can serve as the platform for diverse, vendor-agnostic, intelligent applications. These applications can aim to optimize network performance, but can often encounter conflicts due to differing objectives and strategies.

Effective conflict management in such a complex environment can be essential to maintain network efficiency, reliability, and performance. As network topologies and user demands evolve, a challenge can lie in creating a conflict mitigation strategy that can adapt in real-time, understand network interactions, and preserve the optimization goals of individual applications without compromising network performance.

A new approach to conflict mitigation as described herein in various embodiments is thus beneficial-one that transcends traditional approaches, and utilizes a forward-looking, data-driven model that can anticipate and adapt to the dynamic nature of O-RAN operations. This approach can ensure a balanced network where resources are optimally allocated, and that potential application conflicts are proactively managed to sustain continuous operations and user satisfaction.

The present techniques can be implemented to harmonize operations of various applications within an O-RAN framework, leveraging insights from network data to inform strategic decisions. An objective can be to provide a system that not only responds to conflicts as they arise, but also learns from each event, refining its strategies to prevent future issues, thereby maintaining high standards of network performance that can be expected in the evolving O-RAN ecosystem.

It can be appreciated that the present techniques can generally be applied to platforms deploying multiple applications.

A problem in O-RAN conflict mitigation can lie in developing a strategy that not only resolves conflicts post-detection, but also preserves the intent and optimization goals of each individual xApp. This challenge can involve:
Understanding complex interactions: With numerous xApps operating simultaneously, it can be that a network must understand the complex and often non-linear interactions that can lead to both overt and subtle conflicts.
Maintaining network performance: It can be that a mitigation strategy must ensure that network performance and user experience are not compromised, balancing the competing demands of various xApps.
Ensuring real-time responsiveness: It can be that a mitigation system must operate in real-time, particularly at the near-RT RIC layer, to respond promptly to dynamic network conditions and user behaviors.
Adapting to evolving network conditions: As network topologies and user demands evolve, it can be that the mitigation strategies are to be adapted accordingly, e.g., involving a system that learns and evolves over time.
Handling multi-vendor environment: The diverse origins of xApps can introduce an additional layer of complexity, as different vendors can have unique operational logic and optimization goals.
Sustaining continuous operations: It can be that mitigation actions must be sustainable, avoiding quick fixes in favor of long-term solutions that support continuous network operations.

A mitigation process can encompass strategies and mechanisms designed to harmonize the operations of various xApps, ensuring that their collective actions contribute positively to the network's performance. This can involve a series of steps, beginning with an assessment of detected conflicts, and ending with an implementation of resolution strategies that prevent or resolve conflicts without compromising individual xApp functionalities or network integrity.

### Example Architectures and Signal Flow

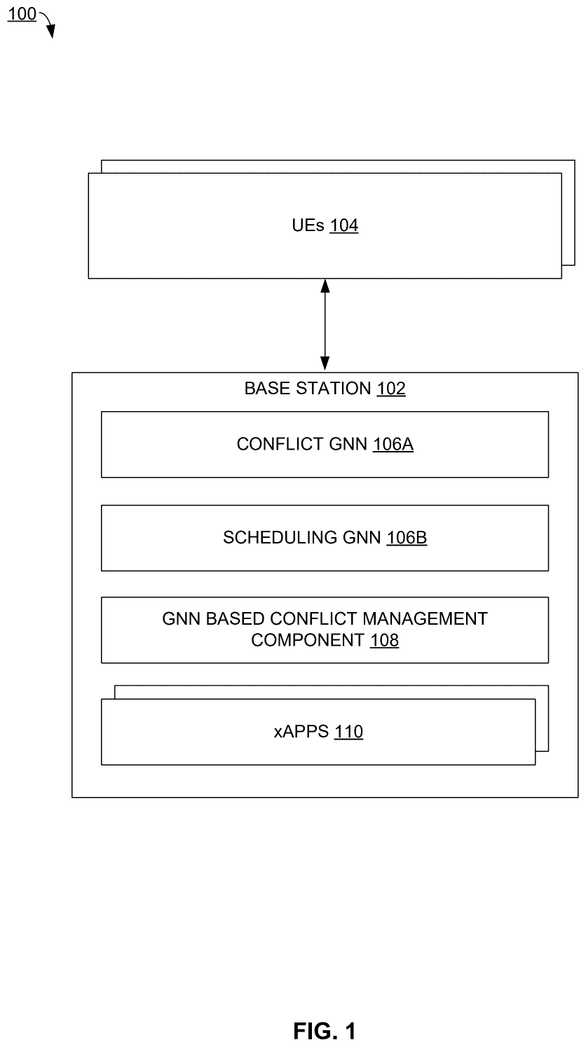

FIG. 1 illustrates an example system architecture 100 that can facilitate GNN-based conflict mitigation, in accordance with an embodiment of this disclosure.

System architecture 100 comprises base station 102 and UEs 104. In turn, base station 102 comprises conflict GNN 106A, scheduling GNN 106B, GNN-based conflict mitigation component 108, and xApps 110.

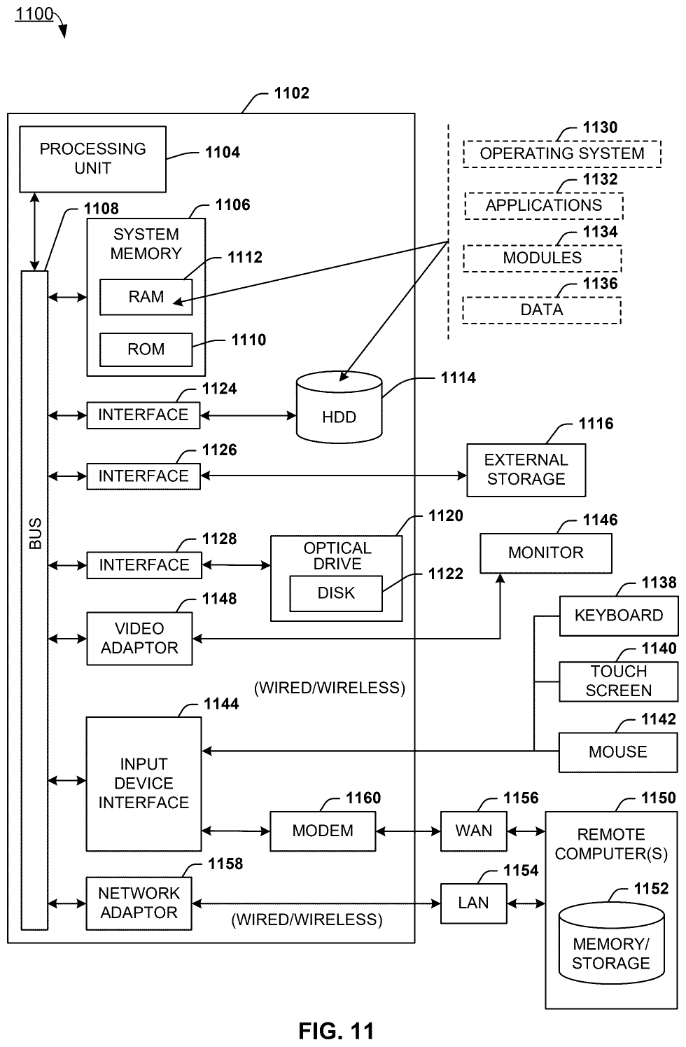

Each of base station 102 and/or UEs 104 can be implemented with part(s) of computing environment 1100 of FIG. 11.

GNN-based conflict mitigation component 108 can identify potential conflicts in running xApps of xApps 110. In doing so, GNN-based conflict mitigation component 108 can leverage two GNNs—conflict GNN 106A and scheduling GNN 106B, as described herein.

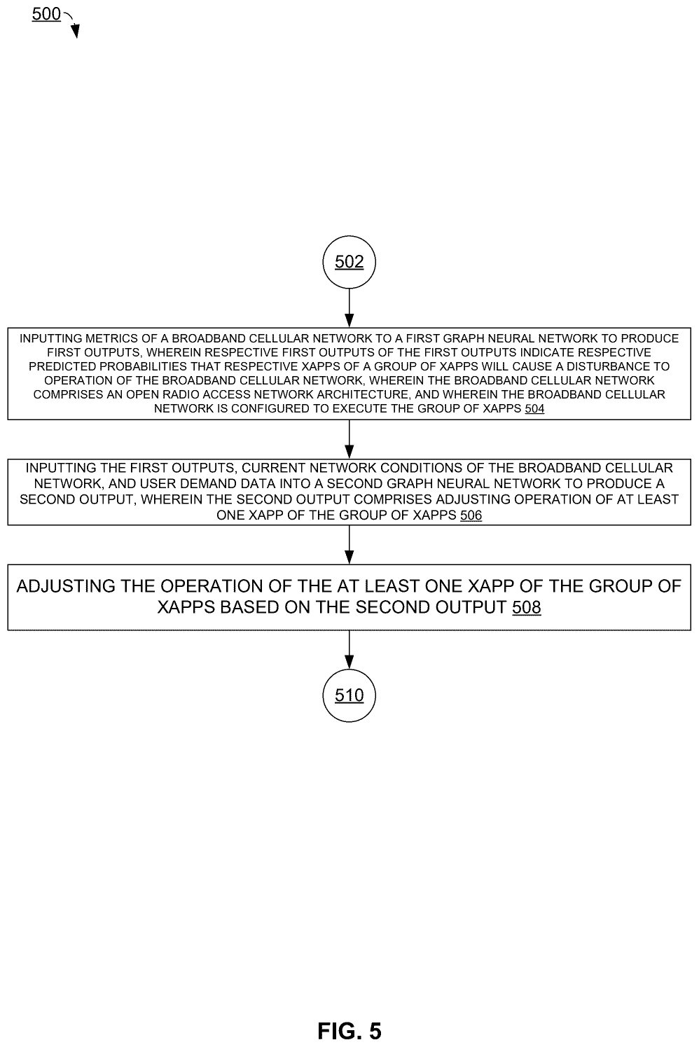

In some examples, GNN-based conflict mitigation component 108 can implement part(s) of the process flows of FIGS. 5-10 to facilitate GNN-based conflict mitigation.

It can be appreciated that system architecture 100 is one example system architecture for GNN-based conflict mitigation, and that there can be other system architectures that facilitate GNN-based conflict mitigation.

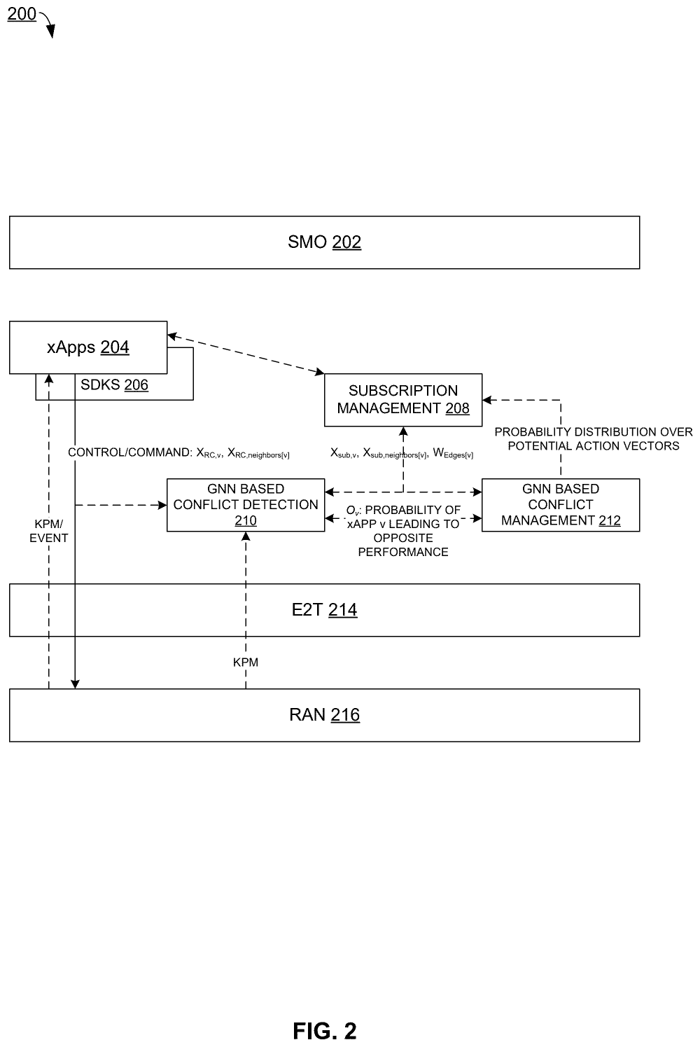

FIG. 2 illustrates another example system architecture 200 that can facilitate GNN-based conflict mitigation, in accordance with an embodiment of this disclosure. In some examples, part(s) of system architecture 200 can be implemented by part(s) of system architecture 100 of FIG. 1 to facilitate GNN-based conflict mitigation.

System architecture 200 comprises service management and orchestration (SMO) 202, xApps 204, software development kits (SDKs) 206, subscription management 208, GNN based conflict detection 210, GNN based conflict management 212, E2 terminal E2T 214 (an endpoint of an E2 interface, such as on a near-real time RIC side or an E2 node side), and RAN 216.

In a dynamic realm of O-RAN, where multiple xApps can compete for network resources, real-time scheduling informed by conflict probabilities can emerge as a solution. A conflict detection engine, which can comprise a component of the network's AI capabilities, can feed into a scheduling system with precise probability metrics that gauge the potential for each xApp to cause network disruptions. This data, in conjunction with real-time network conditions and user demand insights, can drive an xApp scheduling policy.

This process can integrate conflict detection integration. Each probability output can be analyzed, establishing thresholds that determine a risk associated with xApp operations. When an xApp's actions cross this risk threshold, the scheduling policy can intervene, by delaying, advancing, or reconfiguring the execution of xApp actions to align with overarching network objectives, like throughput optimization or latency minimization. The mitigation engine's integration into the near-RT RIC platform is illustrated in FIG. 2.

This scheduling policy can be governed by a group of decision criteria that are informed by network data and outputs from the conflict detection engine. These criteria can form a basis for prioritization rules, determining which xApps receive precedence based on their criticality to network performance and their potential to cause conflicts. An aim can be to ensure network harmony and efficiency, while adhering to strategic goals of an O-RAN environment.

Addressing the above-mentioned challenges, the conflict mitigation framework can utilize outputs from the GNN-based conflict detection system to inform its strategies. It can prioritize conflicts based on their potential impact on network performance and user experience, formulating resolution strategies that can range from parameter adjustments to resource reallocation. The implemented strategies can be monitored for effectiveness, and results can be fed back into the system to refine a GNN model, which can lead to the model becoming more precise at predicting and preventing conflicts over time.

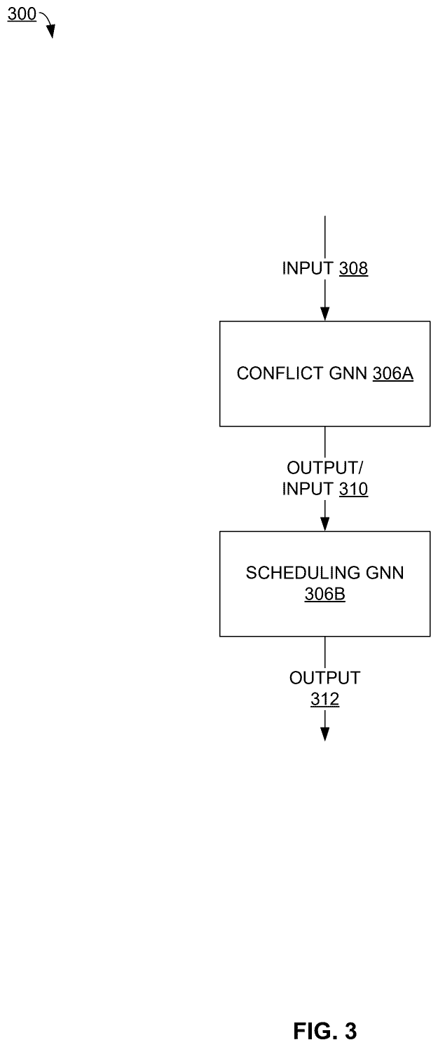

FIG. 3 illustrates an example system architecture 300 of a GNN that can facilitate GNN-based conflict mitigation, in accordance with an embodiment of this disclosure. In some examples, part(s) of system architecture 300 can be implemented by part(s) of system architecture 100 of FIG. 1 to facilitate GNN-based conflict mitigation.

System architecture 300 comprises conflict GNN 306A and scheduling GNN 306B, which can be similar to conflict GNN 106A and scheduling GNN 106B of FIG. 1, respectively. System architecture 300 also comprises input 308, output/input 310, and output 312.

Input 308 can be an input to conflict GNN 306A. Output/input 310 can be an output of conflict GNN 306A that is also an input to scheduling GNN 306B. Output 312 can be an output of scheduling GNN 306B. In this manner conflict GNN 306A and scheduling GNN 306B can work in conjunction to identify potential conflicts between xApps and make scheduling decisions based on that information.

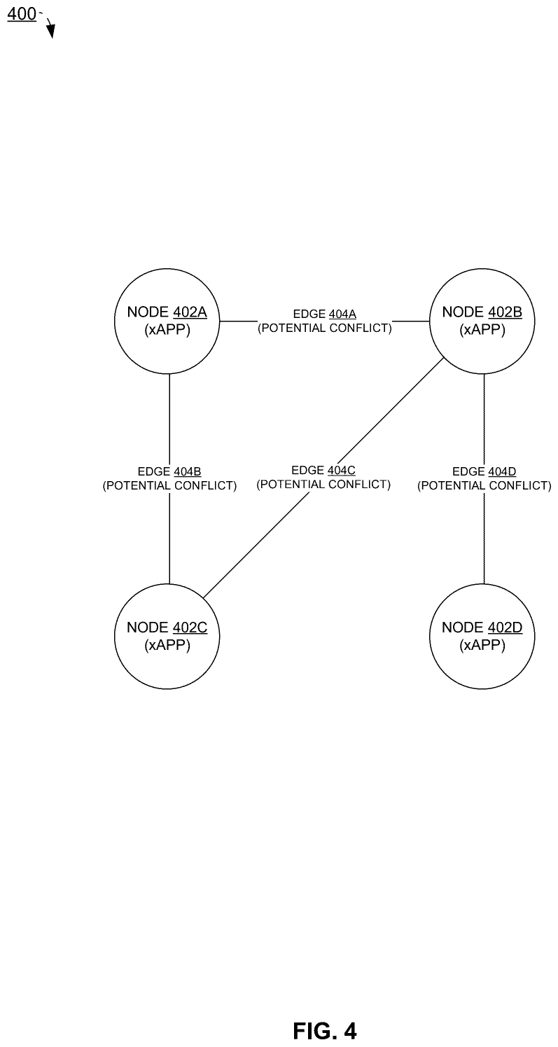

FIG. 4 illustrates an example graph 400 that can facilitate GNN-based conflict mitigation, in accordance with an embodiment of this disclosure. In some examples, part(s) of graph 400 can be implemented by part(s) of system architecture 100 of FIG. 1 to facilitate GNN-based conflict mitigation.

Graph 400 comprises node 402A (xApp), node 402B (xApp), node 402C (xApp), node 402D (xApp), edge 404A (potential conflict), edge 404B (potential conflict), edge 404C (potential conflict), and edge 404D (potential conflict). The nodes of graph 400 (node 402A (xApp), node 402B (xApp), node 402C (xApp), and node 402D (xApp)) can represent xApps, such as xApps 110 of FIG. 1. The edges of graph 400 (edge 404A (potential conflict), edge 404B (potential conflict), edge 404C (potential conflict), and edge 404D (potential conflict)) can represent potential conflicts between those xApps in executing those xApps. This type of graph representation can be used by conflict GNN 106A and scheduling GNN 106B to facilitate GNN-based conflict mitigation.

GNN-driven conflict mitigation can be implemented as follows. The GNN model can be used in conflict mitigation, tasked with an objective of orchestrating a harmonious network environment. With inputs derived from a conflict detection engine, the GNN model can absorb probabilities implicating each xApp's likelihood of causing a conflict. The model's architecture can be designed to process these inputs, along with network state data and xApp interaction patterns, to output strategic decisions that can guide a scheduling or adjustment of xApp operations.

Graph construction can be a process within the GNN model where xApps are represented as nodes within a network graph, and potential conflicts are represented as edges. It can be that this graph is not just a static representation, but a living structure that continuously adapts to the changing network landscape. Each node and edge can be enriched with features such as xApp characteristics, historical performance, and dependency information, providing a blueprint of the network's operational state. In some examples, for the GNN-based conflict mitigation strategy, there can be the following objectives, inputs, outputs, features, and states.
Objective: to mitigate conflicts among xApps in a network, based on a probability of each xApp leading to opposite or conflicting directions.
Inputs: the primary inputs can be probabilities indicating a likelihood of each xApp causing a conflict.
Outputs: the outputs are decisions or recommendations on how to schedule or adjust xApp actions to minimize conflicts.
Features: features can include xApp characteristics, network state data, and interaction patterns between xApps.
States: states can refer to a status of each xApp and the overall network conditions (e.g., xApp status: delayed, advanced, idle, active).

The GNN layers, including convolutional layers and attention mechanisms, can distill this graph into an actionable state representation. This state encapsulation can allow the model to propose conflict predictions and corresponding mitigation strategies. The model's training process, utilizing a loss function that can focus on minimizing conflict occurrences, can refine its predictive accuracy, and can ensure that the GNN model becomes increasingly adept at recommending the most effective scheduling adjustments. A GNN-based structure for conflict mitigation can comprise the following aspects:
Graph Construction:
   Nodes: Represent xApps deployed in the network.
   Edges: Reflect the interactions or potential conflicts between xApps.
   Node Features: Characteristics of xApps (e.g., type, priority, and/or historical performance).
   Edge Features: Information about a relationship between xApps (e.g., historical conflict rate, and/or dependency).
Input Layer:
   Data Ingestion: Incorporate probabilities of each xApp leading to a conflicting action.
Feature Engineering:
   Network Data: Incorporate real-time network metrics/key performance indicators (KPIs) (e.g., traffic load, and/or resource utilization).
   Temporal Dynamics: Account for changes over time in network conditions and xApp behavior.
   Historical Data: Include historical conflict occurrences and resolutions.
GNN Layers:
   Convolutional Layers: Apply graph convolution to aggregate information from neighboring nodes (xApps).
   Attention Mechanisms: Implement graph attention networks (GAT) to weigh an importance of neighboring nodes differently.
State Representation:
   Embedding Layer: Generate embeddings representing a current state of each xApp, and the overall network.
   Temporal Layer: In some examples, use layers like long short-term memory networks (LSTMs) to capture temporal dynamics.
Output Layer:
   Conflict Prediction: Output a likelihood of conflicts arising from a current network state.
   Action Recommendations: Suggest scheduling adjustments, or other actions, to mitigate predicted conflicts.
Training:
   Loss Function: Define a loss function that penalizes conflict occurrences. This can be the case for a reinforcement learning (RL) approach. In some examples, a supervised approach can be utilized.

By integrating this example mitigation framework within an O-RAN architecture, networks can be equipped to resolve conflicts proactively, preserving the network's integrity and user satisfaction. This approach can advance capabilities of RIC-based O-RAN networks, and can also align with an overarching vision of creating a more intelligent, robust, and efficient RAN ecosystem.

Strategic scheduling adjustments for optimized (or satisfactory) xApp execution can be implemented as follows. Scheduling adjustments can comprise a strategic response to a GNN model's predictions, encompassing a variety of actions, such as modifications to an execution plan, reallocation of resources, and/pr adjustments to operational parameters. In some examples, scheduling adjustments can be defined as:
Execution Plan Adjustment:
   Delay or Advance Execution: Adjust the timing of an xApp's operation, either delaying or advancing its execution.
   Sequential or Parallel Execution: Decide whether xApps should run sequentially or in parallel, based on their interdependencies and conflict probabilities.
Resource Allocation Adjustment:
   Change an allocation of network resources (e.g., bandwidth, computing power, and/or change of E2 nodes where the xApp is applied) to an xApp.
Parameter Modification:
   Tweak operational parameters of xApps (e.g., sensitivity settings, and/or thresholds).
Prioritization Changes:
   Alter the priority levels of certain xApps, giving precedence to those deemed important for network performance.

In some examples, it can be that these adjustments are not arbitrary; rather, they can follow a procedure that interprets the model's predictions, with each potential conflict assigned a probability score. Decision thresholds can then be established, beyond which action can be deemed recommended or necessary to preemptively address an impending conflict.

The actions themselves can be ranked based on their predicted effectiveness, allowing for a selection of the most appropriate strategy within the network. This selection process can be used to determine an operational tempo of the network, which can dictate whether xApps should operate in sequence or parallel, and how resources should be distributed among them. Prioritization changes can also be considered, as certain xApps can be elevated in importance to ensure network stability and performance. An example scheduling adjustment procedure can be summarized as:
Interpreting Model Predictions:
   Conflict Probability: The GNN model can output a probability or a score indicating a likelihood of a conflict between xApps.
   Action Scores: The model can also output scores representing an effectiveness of potential actions (e.g., delaying, advancing, and/or modifying parameters of an xApp).
Decision Thresholds:
   Conflict Threshold: Set a threshold for a conflict probability above which an action can be deemed recommended or necessary.
   Action Thresholds: Define thresholds for action scores to determine appropriate (or most appropriate) actions.
Action Selection:
   Ranking Action vectors: Based on the scores, rank potential scheduling adjustments.
   Selecting the Best Action: Choose an action or a set of actions that are predicted to reduce (or best reduce) the conflict probability.

Conflict resolution strategies can be part of an adjustment procedure, and can emphasize mitigation actions as a first line of defense. It can be that flexibility is built into a system according to the present techniques, with fallback strategies that can ensure network integrity in the face of unforeseen challenges. Fallback strategies can encompass alternative actions for conflict mitigation, which can include rule-based xApp planning, triggering xApp retraining, declaring training data as obsolete, and/or initiating the collection of new data records. A GNN model's outputs, converted into a probability distribution over potential actions by a softmax layer, can guide these strategies, and can provide a quantitative basis for decision-making.

Continuous learning and adaptation of conflict management can be implemented as follows. An element of a conflict mitigation framework can be its capacity for continuous learning and adaptation. It can be that this is not a static system, but one that evolves with the network it governs. A performance of each scheduling adjustment can be monitored, with feedback serving as a learning input for the GNN model. In some examples, this feedback loop can ensure that the model's predictions and the resultant scheduling actions become more refined and effective over time, incorporating new data and outcomes to improve future performance.

The model's adaptability can facilitate a sustainability of the O-RAN network. As the model learns from the outcomes of its decisions, it can become more adept at navigating a complex and ever-changing landscape of network management. In some examples, this capacity for continuous improvement can be what makes the conflict mitigation solution not just a tool for current challenges, but also a foundation for a future of an O-RAN ecosystem.

The present techniques can be implemented to facilitate a strategic utilization of a GNN in an O-RAN for predictive conflict management.

A GNN-based conflict mitigation engine for O-RAN can incorporate a blend of predictive analytics, real-time data processing, and intelligent decision-making to redefine how modern telecommunication networks handle internal application conflicts.

Integration of conflict detection engine output can be performed as follows. A utilization of output from the conflict detection engine can be performed. By integrating a probability metric that quantifies the potential for xApp actions to lead to network congestion or other adverse effects, the system can facilitate anticipatory network management. This probability metric can comprise an input that drives decision-making techniques within the GNN model. The integration of this metric can facilitate a data-driven approach to conflict resolution that is both dynamic and adaptive to a fluid nature of network conditions.

A comprehensive GNN model structure and functionality can be implemented as follows. The GNN model's architecture can be built with a level of comprehensiveness that captures a complexity of RANs. It can operate on a graph-based representation of the network, where xApps are represented as nodes, and potential conflicts between xApps are depicted as edges. This graph-based approach can facilitate handling a multi-dimensional nature of network operations, enabling the model to assess and understand the probabilities of conflicts from a panoramic viewpoint. This holistic perspective can enable the model to evaluate and predict the myriad ways in which xApps can interact and potentially conflict, leading to a more proactive and nuanced conflict mitigation strategy.

Advanced GNN layers and state representation mechanisms can be implemented as follows. Graph convolutional layers and graph attention networks (GAT) can be utilized to analyze the interconnected data, discerning a significance of the relationships between nodes. This can allow for a prioritized and informed approach to the management of xApp interactions, going beyond mere data aggregation to a more refined understanding of network dynamics. The embedding and temporal layers can provide a temporal and nuanced state representation of each xApp and the network, which can ensure that decision-making is grounded in both real-time and historical network data.

A strategic output layer design and training methodology can be as follows. The output layer of the GNN model can be designed to deliver strategic and actionable insights. This aspect of the model can translate complex graph-based analysis into clear predictions and recommendations for network conflict mitigation. The training methodology, which can comprise a specialized loss function designed to penalize the emergence of conflicts, can emphasize the model's commitment to minimizing network disruptions. This proactive training approach can ensure that the network is not only responding to conflicts as they arise, but is learning from each event to prevent future occurrences.

An integration of conflict detection engine output can be as follows. The system can utilize a probability metric, derived from the conflict detection engine, which can assess a likelihood of adverse effects, such as network congestion due to xApp actions. This metric can lay the groundwork for the GNN model's decision-making process.

GNN model structure and functionality can be as follows. The GNN model can aim to mitigate conflicts among xApps by evaluating a probability of each xApp leading to conflicting directions. Furthermore, the graph-based representation of the network, where nodes represent xApps and edges reflect potential conflicts, can capture complex dynamics of network operations and xApp interactions.

GNN layers and state representation mechanisms can be as follows. The layers and mechanisms in the GNN model, such as graph convolutional layers and graph attention networks (GAT), can allow for a comprehensive understanding of network relationships by differentiating the importance of neighboring nodes. Additionally, an inclusion of embedding and temporal layers to represent a state of each xApp and the overall network can ensure that both current states and historical trends are considered in decision-making.

Strategic output layer design and training methodology can be as follows. The model can output conflict predictions and actionable recommendations, which can be influenced by integrated conflict probabilities and network data. This can enable proactive network management. The specialized loss function, which can penalize conflict occurrences, can underscore the model's focus on minimizing network conflicts.

Adaptive conflict resolution strategies can be implemented as follows. A GNN-based O-RAN management system according to the present techniques can facilitate adaptive conflict resolution strategies that marry the predictive skill of graph neural networks with the dynamic requests or needs of modern telecommunication infrastructures. These strategies can showcase an integration of artificial intelligence (AI) with network operations, facilitating responsive and intelligent network management.

Holistic scheduling and real-time adaptation can be implemented as follows. It can be that scheduling adjustments and procedures derived from the GNN model's predictions are not just about making real-time responses to network conditions but about creating a system that is holistic in its approach. The GNN model can provide a broad spectrum of data analytics that translates into timing adjustments for xApp operations, resource reallocation across the network, and dynamic changes in xApp prioritization. This web of actions can create a feedback loop that constantly informs the network management actions with refined data, allowing for an understanding of network dynamics. It is this in-depth analysis and subsequent action that can enable network operators to maintain a balanced ecosystem, efficiently distributing network resources to where they are requested or needed, and preemptively addressing potential conflicts.

The decision-making process regarding the execution of xApps, whether to run them sequentially or in parallel, can be informed by an understanding of their interdependencies and the probabilities of conflict they can introduce. This is where a system's capacity for dynamic scheduling can come into play. By considering these factors, the system can ensure that network operations are not just reactive but proactive, avoiding potential bottlenecks and optimizing network performance.

Interconnected model predictions and decision thresholds can be implemented as follows. The GNN model's predictions can be linked with the decision thresholds set within the system, providing a clear roadmap for network operators on the actions implicated or needed to maintain network integrity. By utilizing conflict probabilities and action scores generated by the GNN model, the system can offer a proactive strategy for network management. It can be that these decision thresholds are not arbitrary; rather, they can be calibrated to the network's demands, ensuring that interventions are timely and effectively mitigate potential disruptions. This level of precision in the decision-making process can aid in reducing network disruptions and maintaining a high quality of service.

The thresholds for conflicts and actions can be set based on network analysis, allowing for a responsive yet controlled approach to network management. When a probability of a conflict crosses a predefined threshold, the system can be primed to intervene, deploying actions to preemptively resolve the issue. These actions can be ranked and selected based on their effectiveness and urgency, ensuring that the network operates smoothly. This level of detail in the model's predictive analytics can demonstrate the system's capacity to not only understand, but also to act upon, the nuances of network operations.

Resolutions and output layer customization can be as follows. The system's conflict resolution capabilities can comprise an output layer configuration. This layer can be the culmination of the system's analysis, where the interactions and potential conflicts identified by the GNN model can be converted into a range of actionable vectors. By utilizing a softmax layer, the system can translate these vectors into a probability distribution, providing a quantifiable way for network operators to evaluate and select conflict resolution strategies. This approach can both facilitate a prioritization of mitigation strategies, and also ensure that the network has a suite of fallback options to maintain its resilience.

By providing a clear set of potential actions and their associated probabilities, network operators can be equipped with tools to make informed decisions. This level of detail and customization can ensure that the network is not only robust in the face of conflicts but is also capable of evolving its conflict resolution strategies over time. As the system learns from each instance of conflict and the effectiveness of the resolution strategies, it can continuously refine its predictive models, and can ensure that the network's conflict resolution capabilities are always at the cutting edge.

### Example Process Flows

FIG. 5 illustrates an example process flow 500 for GNN-based conflict mitigation, in accordance with an embodiment of this disclosure. In some examples, one or more embodiments of process flow 500 can be implemented by system architecture 100 of FIG. 1, or computing environment 1100 of FIG. 11.

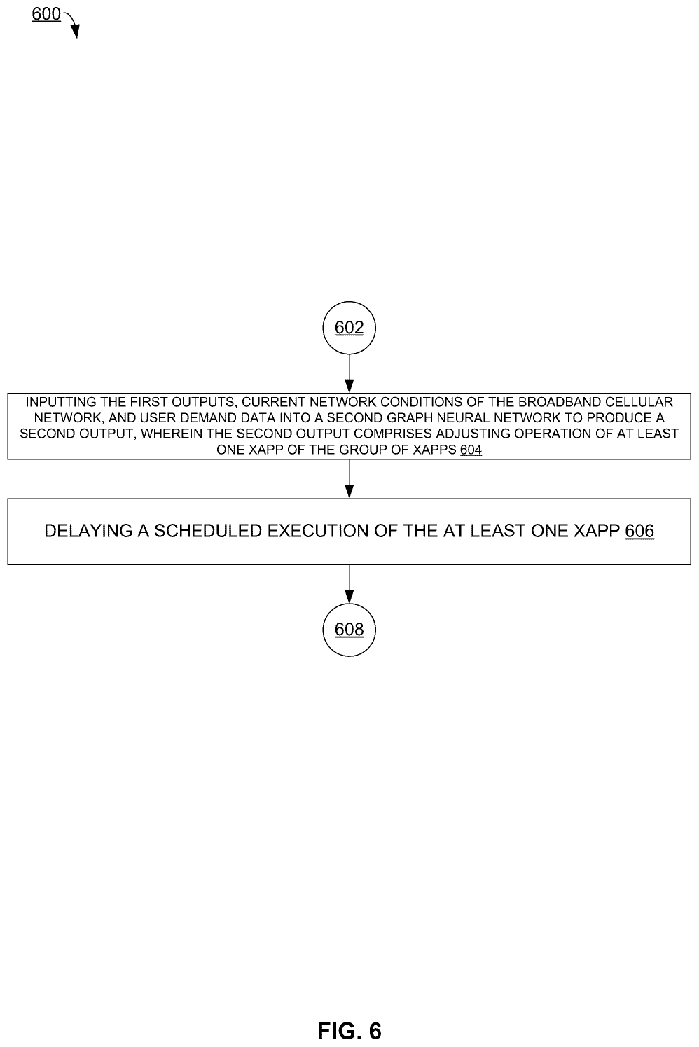

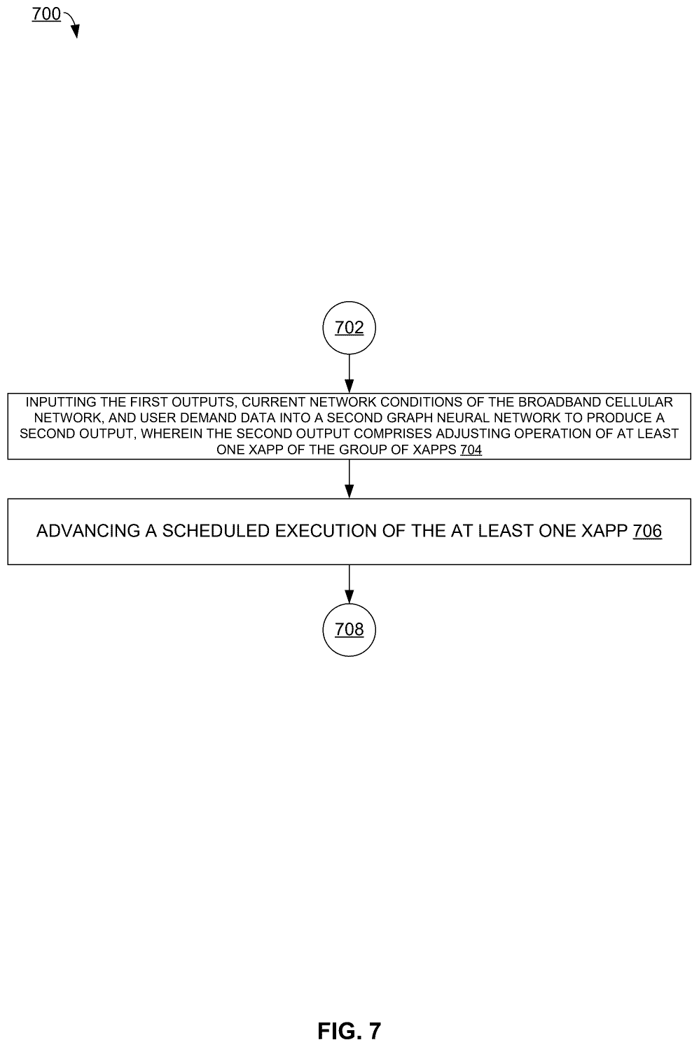

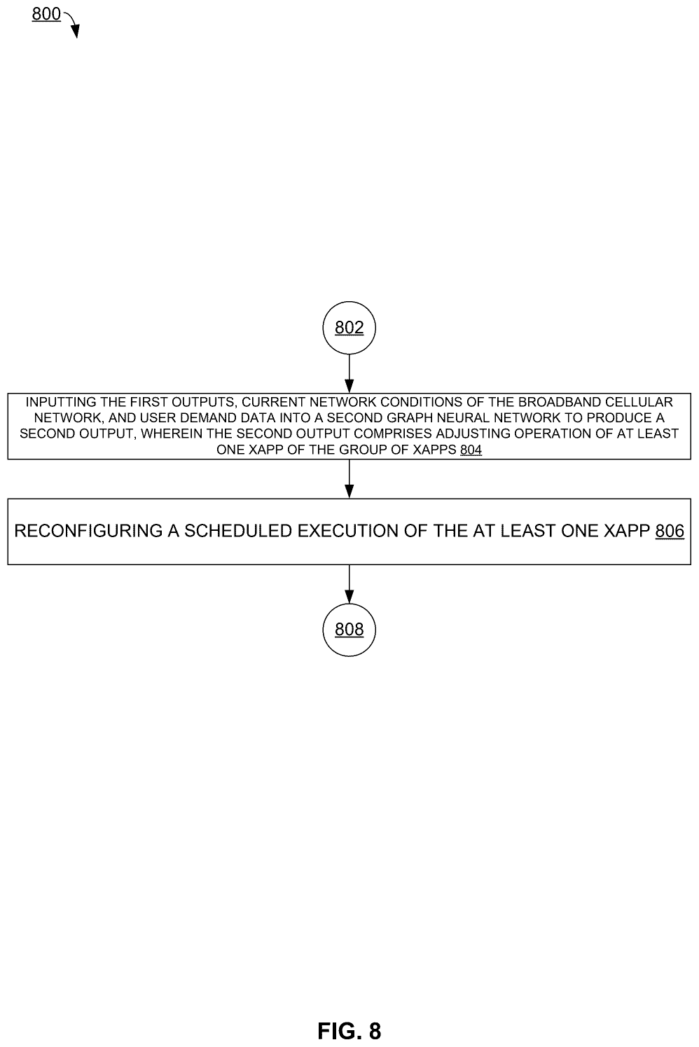

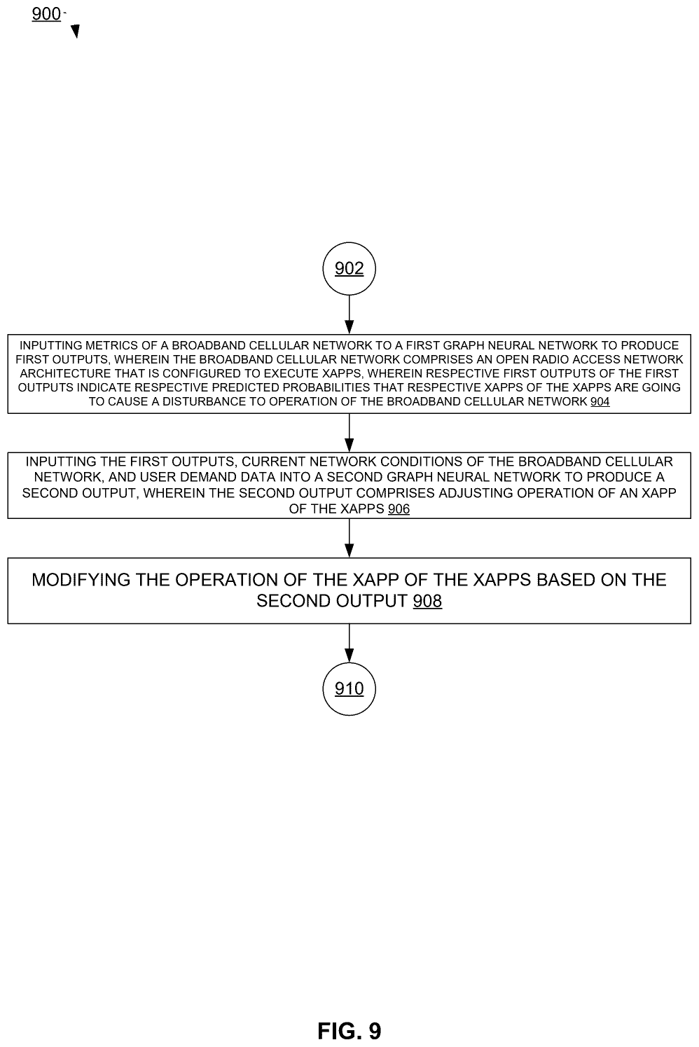

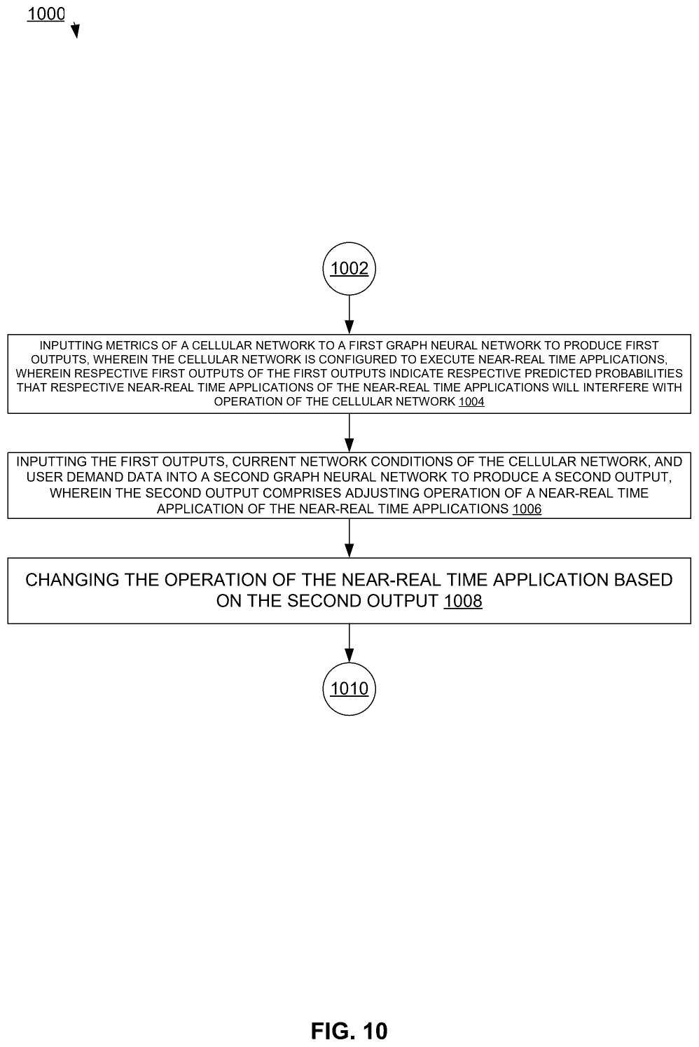

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts inputting metrics of a broadband cellular network to a first graph neural network to produce first outputs, wherein respective first outputs of the first outputs indicate respective predicted probabilities that respective xApps of a group of xApps will cause a disturbance to operation of the broadband cellular network, wherein the broadband cellular network comprises an open radio access network architecture, and wherein the broadband cellular network is configured to execute the group of xApps. That is, a conflict GNN can be used to determine potential conflicts.

After operation 504, process flow 500 moves to operation 506.

Operation 506 depicts inputting the first outputs, current network conditions of the broadband cellular network, and user demand data into a second graph neural network to produce a second output, wherein the second output comprises adjusting operation of at least one xApp of the group of xApps. That is, the result of operation 504 can be input to a scheduling GNN to determine how to adjust operation of an xApp.

In some examples, the second graph neural network is configured to determine respective risk thresholds of the respective xApps, and the second output indicates that the respective predicted probabilities satisfy respective risk threshold criteria that correspond to the respective risk thresholds. That is, when an xApp's actions cross this risk threshold, the scheduling policy can intervene.

In some examples, the second output is based on respective criticality metrics of the respective xApps. That is, a scheduling policy can be governed by a group of decision criteria that are informed by network data and outputs from the conflict detection engine. These criteria can form a basis for prioritization rules, determining which xApps receive precedence based on their criticality to network performance and their potential to cause conflicts. An aim can be to ensure network harmony and efficiency, while adhering to strategic goals of an O-RAN environment.

After operation 506, process flow 500 moves to operation 508.

Operation 508 depicts adjusting the operation of the at least one xApp of the group of xApps based on the second output. That is, operation of the xApp can be adjusted based on the result of operation 506.

In some examples, operation 508 comprises iteratively refining the first graph neural network based on a metric of network performance of the broadband cellular network that occurs subsequent to the adjusting of the operation of the at least one xApp. That is, the implemented strategies according to the present techniques can be monitored for effectiveness, and results can be fed back into the system to refine a GNN model, which can lead to the model becoming more precise at predicting and preventing conflicts over time.

After operation 508, process flow 500 moves to 510, where process flow 500 ends.

FIG. 6 illustrates an example process flow 600 for GNN-based conflict mitigation, in accordance with an embodiment of this disclosure. In some examples, one or more embodiments of process flow 600 can be implemented by system architecture 100 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts inputting the first outputs, current network conditions of the broadband cellular network, and user demand data into a second graph neural network to produce a second output, wherein the second output comprises adjusting operation of at least one xApp of the group of xApps. In some examples, this can be implemented in a similar manner as operation 506 of FIG. 5.

After operation 604, process flow 600 moves to operation 606.

Operation 606 depicts delaying a scheduled execution of the at least one xApp. In some examples, this can be implemented in a similar manner as operation 508, where adjusting the operation in operation 508 comprises delaying the scheduled execution of the at least one xApp.

After operation 606, process flow 600 moves to 608, where process flow 600 ends.

FIG. 7 illustrates an example process flow 700 for GNN-based conflict mitigation, in accordance with an embodiment of this disclosure. In some examples, one or more embodiments of process flow 700 can be implemented by system architecture 100 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts inputting the first outputs, current network conditions of the broadband cellular network, and user demand data into a second graph neural network to produce a second output, wherein the second output comprises adjusting operation of at least one xApp of the group of xApps. In some examples, this can be implemented in a similar manner as operation 506 of FIG. 5.

After operation 704, process flow 700 moves to operation 706.

Operation 706 depicts advancing a scheduled execution of the at least one xApp. In some examples, this can be implemented in a similar manner as operation 508, where adjusting the operation in operation 508 comprises advancing the scheduled execution of the at least one xApp.

After operation 706, process flow 700 moves to 708, where process flow 700 ends.

FIG. 8 illustrates an example process flow 800 for GNN-based conflict mitigation, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 500 of FIG. 5, process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts inputting the first outputs, current network conditions of the broadband cellular network, and user demand data into a second graph neural network to produce a second output, wherein the second output comprises adjusting operation of at least one xApp of the group of xApps. In some examples, this can be implemented in a similar manner as operation 506 of FIG. 5.

After operation 804, process flow 800 moves to operation 806.

Operation 806 depicts reconfiguring a scheduled execution of the at least one xApp. In some examples, this can be implemented in a similar manner as operation 508, where adjusting the operation in operation 508 comprises reconfiguring the scheduled execution of the at least one xApp.

After operation 806, process flow 800 moves to 808, where process flow 800 ends.

FIG. 9 illustrates an example process flow 900 for GNN-based conflict mitigation, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts inputting metrics of a broadband cellular network to a first graph neural network to produce first outputs, wherein the broadband cellular network comprises an open radio access network architecture that is configured to execute xApps, wherein respective first outputs of the first outputs indicate respective predicted probabilities that respective xApps of the xApps are going to cause a disturbance to operation of the broadband cellular network. In some examples, operation 904 can be implemented in a similar manner as operation 504 of FIG. 5.

In some examples, the first graph neural network comprises a graph comprising nodes and edges, respective nodes of the nodes represent respective xApps of the xApps, and respective edges of the edges represent potential conflicts between the xApps. That is, graph construction can be a process within the GNN model where xApps are represented as nodes within a network graph, and potential conflicts are represented as edges.

In some examples, operation 904 comprises updating the graph based on a change to the xApps. That is, it can be that the graph is not just a static representation, but a living structure that continuously adapts to the changing network landscape.

In some examples, at least part of the nodes or the edges comprise first information about a characteristic of at least one xApp of the xApps, second information about historical performance of the broadband cellular network, or third information about a dependency between two xApps of the xApps. That is, it can be that each node and edge can be enriched with features such as xApp characteristics, historical performance, and dependency information, providing a blueprint of the network's operational state. After operation 904, process flow 900 moves to operation 906.

Operation 906 depicts inputting the first outputs, current network conditions of the broadband cellular network, and user demand data into a second graph neural network to produce a second output, wherein the second output comprises adjusting operation of an xApp of the xApps. In some examples, operation 906 can be implemented in a similar manner as operation 506 of FIG. 5.

In some examples, the second graph neural network comprises a layer that comprises a graph attention network that is configured to weight respective importance metrics of respective neighboring nodes of a node of a graph that represents the broadband cellular network. That is,

graph convolutional layers and graph attention networks (GAT) can be utilized to analyze the interconnected data, discerning a significance of the relationships between nodes, and/or to weigh the importance of neighboring nodes differently.

After operation 906, process flow 900 moves to operation 908.

Operation 906 depicts modifying the operation of the xApp of the xApps based on the second output. In some examples, operation 908 can be implemented in a similar manner as operation 508 of FIG. 5.

In some examples, the modifying of the operation of the xApp comprises modifying a parameter of the xApp. In some examples, the modifying of the operation of the xApp comprises modifying a resource allocation of the xApp. That is, the present techniques can prioritize conflicts based on their potential impact on network performance and user experience, formulating resolution strategies that can range from parameter adjustments to resource reallocation.

After operation 908, process flow 900 moves to 910, where process flow 900 ends.

FIG. 10 illustrates an example process flow 1000 for GNN-based conflict mitigation, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 500 of FIG. 5, process flow 600 of FIG. 6, process flow 700 of FIG. 7. process flow 800 of FIG. 8, and/or process flow 900 of FIG. 9.

Process flow 1000 begins with 1002, and moves to operation 1004.

Operation 1004 depicts inputting metrics of a cellular network to a first graph neural network to produce first outputs, wherein the cellular network is configured to execute near-real time applications, wherein respective first outputs of the first outputs indicate respective predicted probabilities that respective near-real time applications of the near-real time applications will interfere with operation of the cellular network. In some examples, operation 1004 can be implemented in a similar manner as operation 504 of FIG. 5.

After operation 1004, process flow 1000 moves to operation 1006.

Operation 1006 depicts inputting the first outputs, current network conditions of the cellular network, and user demand data into a second graph neural network to produce a second output, wherein the second output comprises adjusting operation of a near-real time application of the near-real time applications. In some examples, operation 1006 can be implemented in a similar manner as operation 506 of FIG. 5.

In some examples, the second graph neural network is trained based on a loss function that penalizes occurrences of conflicts between the near-real time applications. That is, the second graph neural network can be trained according to a loss function that can focus on minimizing conflict occurrences, can refine its predictive accuracy, and can ensure that the GNN model becomes increasingly adept at recommending the most effective scheduling adjustments.

After operation 1006, process flow 1000 moves to operation 1008.

Operation 1008 depicts changing the operation of the near-real time application based on the second output. In some examples, operation 1008 can be implemented in a similar manner as operation 508 of FIG. 5.

In some examples, the near-real time application is a first near-real time application, and the changing of the operation of the first near-real time application comprises executing the first near-real time application and a second near-real time application sequentially. In some examples, the near-real time application is a first near-real time application, and the changing of the operation of the first near-real time application comprises executing the first near-real time application and a second near-real time application in parallel. That is, an execution plan adjustment can comprise deciding whether xApps should run sequentially or in parallel, based on their interdependencies and conflict probabilities.

In some examples, the changing of the operation of the near-real time application comprises changing a bandwidth of the near-real time application, a computing power of the near-real time application, or an E2 node to which the near-real time application is applied. That is, an execution plan adjustment can comprise changing an allocation of network resources (e.g., bandwidth, computing power, and/or change of E2 nodes where the xApp is applied) to an xApp.

In some examples, the changing of the operation of the near-real time application comprises changing a sensitivity setting associated with the near-real time application, or a threshold value associated with the near-real time application. That is, an execution plan adjustment can comprise tweaking operational parameters of xApps (e.g., sensitivity settings, and/or thresholds).

After operation 1008, process flow 1000 moves to 1010, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base station 102 and/or UEs 104 of FIG. 1.

In some examples, computing environment 1100 can implement one or more embodiments of the process flows of FIGS. 5-10 to facilitate GNN-based conflict mitigation.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
inputting metrics of a broadband cellular network to a first graph neural network to produce first outputs, wherein respective first outputs of the first outputs indicate respective predicted probabilities that respective xApps of a group of xApps will cause a disturbance to operation of the broadband cellular network, wherein the broadband cellular network comprises an open radio access network architecture, and wherein the broadband cellular network is configured to execute the group of xApps;
inputting the first outputs, current network conditions of the broadband cellular network, and user demand data into a second graph neural network to produce a second output, wherein the second output comprises adjusting operation of at least one xApp of the group of xApps; and
adjusting the operation of the at least one xApp of the group of xApps based on the second output.

2. The system of claim 1, wherein the second graph neural network is configured to determine respective risk thresholds of the respective xApps, and wherein the second output indicates that the respective predicted probabilities satisfy respective risk threshold criteria that correspond to the respective risk thresholds.

3. The system of claim 1, wherein adjusting of the operation of the at least one xApp comprises:
delaying a scheduled execution of the at least one xApp.

4. The system of claim 1, wherein adjusting of the operation of the at least one xApp comprises:
advancing a scheduled execution of the at least one xApp.

5. The system of claim 1, wherein adjusting of the operation of the at least one xApp comprises:
reconfiguring a scheduled execution of the at least one xApp.

6. The system of claim 1, wherein the second output is based on respective criticality metrics of the respective xApps.

7. The system of claim 1, wherein the operations further comprise:
iteratively refining the first graph neural network based on a metric of network performance of the broadband cellular network that occurs subsequent to the adjusting of the operation of the at least one xApp.

8. A method, comprising:
inputting, by a system comprising at least one processor, metrics of a broadband cellular network to a first graph neural network to produce first outputs, wherein the broadband cellular network comprises an open radio access network architecture that is configured to execute xApps, wherein respective first outputs of the first outputs indicate respective predicted probabilities that respective xApps of the xApps are going to cause a disturbance to operation of the broadband cellular network;
inputting, by the system, the first outputs, current network conditions of the broadband cellular network, and user demand data into a second graph neural network to produce a second output, wherein the second output comprises adjusting operation of an xApp of the xApps; and
modifying, by the system, the operation of the xApp of the xApps based on the second output.

9. The method of claim 8, wherein the modifying of the operation of the xApp comprises:
modifying a parameter of the xApp.

10. The method of claim 8, wherein the modifying of the operation of the xApp comprises:
modifying a resource allocation of the xApp.

11. The method of claim 8, wherein the first graph neural network comprises a graph comprising nodes and edges, wherein respective nodes of the nodes represent respective xApps of the xApps, and wherein respective edges of the edges represent potential conflicts between the xApps.

12. The method of claim 11, further comprising:
updating, by the system, the graph based on a change to the xApps.

13. The method of claim 11, wherein at least part of the nodes or the edges comprise first information about a characteristic of at least one xApp of the xApps, second information about historical performance of the broadband cellular network, or third information about a dependency between two xApps of the xApps.

14. The method of claim 8, wherein the second graph neural network comprises a layer that comprises a graph attention network that is configured to weight respective importance metrics of respective neighboring nodes of a node of a graph that represents the broadband cellular network.

15. A non-transitory computer-readable medium comprising instructions that, in response to execution, cause a system comprising at least one processor to perform operations, comprising:
inputting metrics of a cellular network to a first graph neural network to produce first outputs, wherein the cellular network is configured to execute near-real time applications, wherein respective first outputs of the first outputs indicate respective predicted probabilities that respective near-real time applications of the near-real time applications will interfere with operation of the cellular network;
inputting the first outputs, current network conditions of the cellular network, and user demand data into a second graph neural network to produce a second output, wherein the second output comprises adjusting operation of a near-real time application of the near-real time applications; and
changing the operation of the near-real time application based on the second output.

16. The non-transitory computer-readable medium of claim 15, wherein the second graph neural network is trained based on a loss function that penalizes occurrences of conflicts between the near-real time applications.

17. The non-transitory computer-readable medium of claim 15, wherein the near-real time application is a first near-real time application, and wherein the changing of the operation of the first near-real time application comprises:
executing the first near-real time application and a second near-real time application sequentially.

18. The non-transitory computer-readable medium of claim 15, wherein the near-real time application is a first near-real time application, and wherein the changing of the operation of the first near-real time application comprises:
executing the first near-real time application and a second near-real time application in parallel.

19. The non-transitory computer-readable medium of claim 15, wherein the changing of the operation of the near-real time application comprises:
changing a bandwidth of the near-real time application, a computing power of the near-real time application, or an E2 node to which the near-real time application is applied.

20. The non-transitory computer-readable medium of claim 15, wherein the changing of the operation of the near-real time application comprises:
changing a sensitivity setting associated with the near-real time application, or a threshold value associated with the near-real time application.
